(19) United States
(12) Patent Application Publication
(10) Pub. No.: US 2003/0213621 A1
(43) Pub. Date: Nov. 20, 2003

(54) Guide assembly for a core bit

(76) Inventors: Werner Britten, Landsberg (DE); Hans-Werner Bongers-Ambrosius, Munich (DE); Sabine Doberenz, Untermeitingen (DE)

Correspondence Address: DAVID TOREN, ESQ., SIDLEY, AUSTIN, BROWN & WOOD, LLP, 787 SEVENTH AVENUE, NEW YORK, NY, 10019-6018, US

(21) Appl. No.: 10/400,095

(22) Filed: Mar. 25, 2003

(30) Foreign Application Priority Data
Mar. 25, 2002 (DE) 102 13 217.8

(51) Int. Cl. E21B 10/26

(52) U.S. Cl. 175/404; 175/385

(57) ABSTRACT

A guide assembly (1) for a core drill bit (2), which is at least partially guided at an inner wall (3) of the core drill bit (2) and projects radially with projections (10) between the plurality of cutting inserts (5) arranged on a frontal surface of the drill tube (4) of the core drill bit (2), wherein a centering means (6) projects at least axially, in part, beyond the cutting inserts (5), whereby the centering means (6) is shorter than the axial length (L) of the drill tube (4), and is axially spring-biased inside the guide assembly (1) and has limited axial displacement.

### BACKGROUND OF THE INVENTION

The invention relates to a guide assembly for a core bit such as a recess cutter for concrete and masonry that can be removed after drilling.

Such core bits have cutting inserts distributed on the periphery in the form of geometrically undefined cutting edges with a diamond-set matrix or geometrically defined cutting edges with polycrystalline diamonds.

DE 4430141 discloses a guide assembly for core bits having an elongated centering needle passing through the floor of the bit and spring biased guide assembly, wherein the guide assembly is inserted into the hollow shaft of the core bit. Such an elongated, unguided centering needle causes loss of control of the core bit due to the high shear forces when drilling.

DE 4420999 discloses a guide assembly guided in part by radial springs on the inside wall of the core bit has a guide plate radially projected between the cutting inserts of the core bit, which is provided with an axially fixed centering drill. The guide plate has an undercut that can be stopped axially behind the cutting inserts by rotating. The centering drill is a wearing part that is actually unnecessary for centering.

### SUMMARY OF THE INVENTION

The object of the present invention is to provide a guide assembly for a core bit that enables precise drilling without unnecessary wearing parts.

This object is achieved essentially, in accordance with the invention, by a guide assembly for a core drill bit that is at least in part axially guided along the inner wall of the core bit and radially projects with projections between several cutting inserts present on a front end of a bore tube of the core drill bit, whereby there is a coaxial centering means extending at least in part axially beyond the cutting inserts, said centering means being shorter than the axial length of the drilling tube and axially spring-biased and axially limited moveable inside the guide assembly.

By virtue of the centering means being shorter than the axial length of the drilling tube and being axially spring-biased inside of the guide assembly, it runs exclusively at the precise inner wall of the guide assembly and is supported axially over a short distance against shearing forces, whereby precise drilling is made possible.

Advantageously, the centering means is axially spring-biased using a helical compression spring which can be arranged, in a space saving manner, coaxially between the centering means and the guide assembly.

Advantageously, the centering means is a bolt, which is preferably made of hardened steel, with an axially front-end, conical centering tip, whereby centering is done without unnecessary wearing parts when creating a pilot bore hole, for example.

Preferably, the bolt is placed, radially tapered and stepped offset, on a guide rod disposed axially opposite the centering tip, whereby it serves as an axial stop for the helical compression spring.

Advantageously, the bolt is fixed against rotation in the guide assembly, whereby wear and tear due to relative rotation can be avoided.

Advantageously the guide assembly has an undercut that by rotating can be axially arrested behind the cutting inserts, whereby the guide assembly is prevented from falling out.

Advantageously, the guide assembly has a coaxially guided, sleevelike insert means on the inner wall of the core drill bit, which is made of plastic, thereby assuring simple manufacturing by injection molding, for example.

Advantageously, the insert means has at least three guide surfaces arranged peripherally, advantageously equally spaced, on the inner diameter of the associated core drill bit, which extend at least partially axially, whereby coaxial guiding is possible in a simple manner.

Advantageously, the insert means features peripheral spaced, radial, multiple discrete offset guide surfaces, whereby a single guide assembly for core drill bits of different diameters is required.

Advantageously, the guide surfaces are arranged adjacent to the projections, whereby uptake of the shearing forces occurs directly at the front of the drill tube having the cutting inserts.

### BRIEF DESCRIPTION OF THE INVENTION

The exemplary embodiment of the invention is more completely described below with reference to the following drawings, wherein:

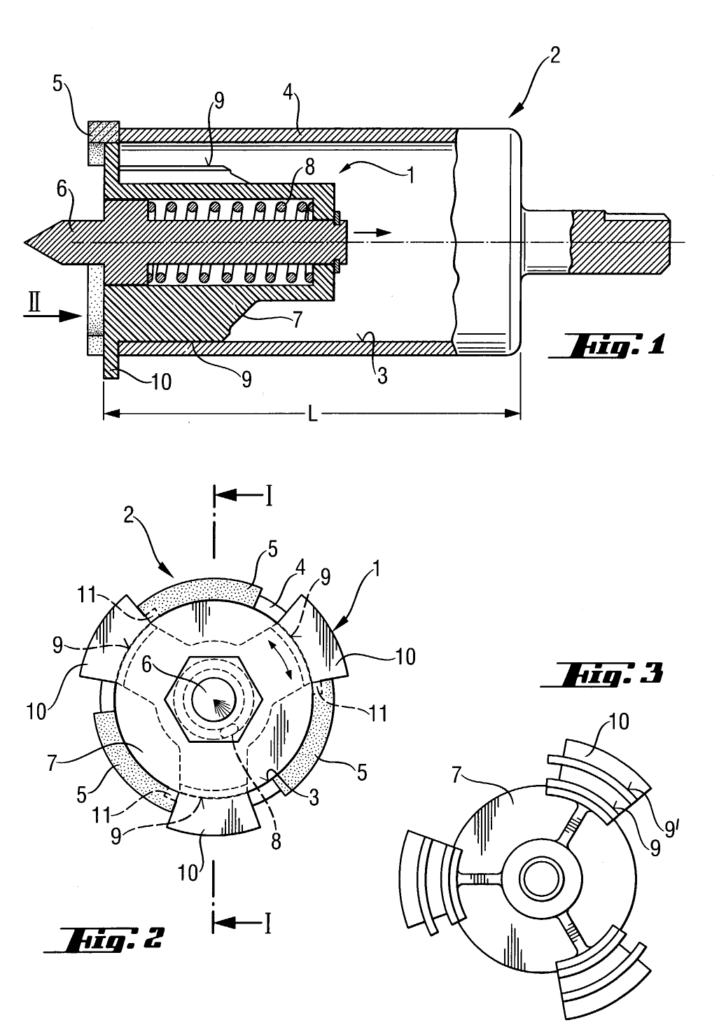

FIG. 1 shows a guide assembly in partial longitudinal section, according to the invention;

FIG. 2 shows the guide assembly of FIG. 1, in frontal view; and

FIG. 3 shows a rear view of a variant, insert means only, according to the invention.

### DETAILED DESCRIPTION OF THE INVENTION

According to FIG. 1, a guide assembly 1 for a core drill 2 is shown, in longitudinal section partially axially guided at an inner wall 3 of the core drill bit, radially projecting between the plurality of cutting inserts 5 at a frontal face of a drill tube 4 of the core drill bit and axially abutting on the frontal face of the drill tube 4. A coaxial centering means 6 partially extends axially beyond the cutting tools 5 and is configured as a bolt with an axial frontal, conical centering tip of a radially tapered, stepwise offset guide shaft. The centering means 6 is shorter than the axial length of the drill tube 4, opposite a sleevelike insert means 7 and spring-biased axially by a helical compression spring 8 coaxially arranged between the guide shaft of the centering means 6 and the insert means 7 and axial limited movement. The insert means 7 features peripherally spaced guide surfaces 9, on the periphery of the inner diameter of the associated core drill bit 2, which extend axially, in part, and are directly adjacent to radial projections 10.

FIG. 2 shows the guide assembly means 1 viewed from the front with its three radial projections 10 fitting into the gaps between the three cutting inserts 5 of the core drill bit 2 and each having an web 11 that can be axially arrested by rotation locked behind the cutting inserts 5. The bolt 6 is guided rotationally fixed and limited and axially displaceable by a hexagonal section in the insert means 7.

FIG. 3 shows a variant suitable for two core drill bits of different diameters featuring insert means 7 (shown viewed from the rear) peripherally spaced, and radial double offset guiding surfaces 9, 9′, which extend partially axially and are adjacently arranged directly with the three paired common radial projections 10. Such a variant for an additional number of different diameters, for example three or four, can be configured with triple or quadruple radially discretely offset guide surfaces 9.

What is claimed is:

1. A guide assembly (1) for a core drill bit (2) being at least partially axially guided on an inner wall (3) of the core drill bit (2) and projecting with projections (10) positioned radially between a plurality of cutting inserts (5) disposed at a frontal end of a drill tube (4) of the core drill bit (2), wherein a protruding coaxial centering means (6) at least partially projects beyond the cutting inserts (5), and wherein the centering means (6) is shorter than an axial length (L) of the drill tube (4) and is axially spring-biased inside the guide assembly (1) and has limited axial displacement.

2. The guide assembly (1) of claim 1, wherein the centering means (6) is axially spring-biased by a helical compression spring (8).

3. The guide assembly of claim 1, wherein the centering means (6) is a bolt having an axial, frontal, conical centering tip.

4. The guide assembly of claim 3, wherein the bolt is radially tapered and stepwise offset at a guide shaft arranged axially opposite the centering tip.

5. The guide assembly of claim 3, wherein the bolt is fixed against rotation in the guide assembly.

6. The guide assembly of claim 1, further including a web (11) axially lockable, by rotation, behind the cutting inserts (5).

7. The guide assembly of claim 1, further including a sleeve-like insert means (7) coaxially guided at the inner wall (3) of the core drill bit (2).

8. The guide assembly of claim 7, wherein the insert means (7) has at least three equally spaced guide surfaces (9, 9′) arranged on the periphery of an inner diameter of an associated core drill bit (2) and extending axially.

9. The guide assembly of claim 8, wherein the insert means (7) has peripherally spaced, radial multiple discretely offset guide surfaces (9, 9′).

10. The guide assembly according of claim 8, wherein the guide surfaces (9, 9′) are arranged adjacent to radial projections (10).

11. The guide assembly of claim 3, wherein the centering means (6) is made of hardened steel.

12. The guide assembly of claim 1, wherein the sleeve-like insert means (7) is made of plastic.
